(19) United States
(12) Patent Application Publication
(10) Pub. No.: US 2020/0260302 A1
(43) Pub. Date: Aug. 13, 2020

(54) PORTABLE RADAR DETECTION DYNAMIC FREQUENCY SELECTION AUTOMATIC TEST DEVICE

(71) Applicant: Sporton International Inc., New Taipei City (TW)

(72) Inventors: CHIN-HONG YAO, Taoyuan City (TW); JYUN-SIAN LI, Taoyuan City (TW)

(21) Appl. No.: 16/282,368

(22) Filed: Feb. 22, 2019

(30) Foreign Application Priority Data
Feb. 13, 2019 (TW) 108201879

(51) Int. Cl. H04W 24/06; H04L 12/26

(52) U.S. Cl. CPC H04W 24/06; H04L 43/0811

(57) ABSTRACT

A portable radar detection dynamic frequency selection automatic test device is provided, which includes a radar signal generator and a computer host. The radar signal generator is plugged into an USB connection interface to connect to the computer host connected to a wireless network device. The computer host transmits a radar signal file via the USB connection interface to generates a radar signal and transits the radar signal to a wireless network device via a radar transmission interface. Meanwhile, a processing unit of the computer host performs a radar detection rate test in order to determine whether the wireless network device detects the radar signal.

### BACKGROUND OF THE INVENTION

### 1. Field of the Invention

The present invention relates to a radar detection device for wireless network devices, in particular to a compact portable radar detection dynamic frequency selection automatic test device easy to carry around and able to automatically determine test results.

### 2. Description of the Prior Art

In recent years, wireless network devices should have the radar dynamic frequency selection function within 5250-5350 MHz and 5470-5725MH in order to prevent the radar from being interfered. The requirements of KDB 905462 7.8.1—U-NII Detection Bandwidth announced by Federal Communications Commission (FCC) are as follows:

1. Generate a single radar burst, and note the response of the UUT. Repeat for a minimum of 10 trials. The UUT must detect the radar waveform within the DFS band using the specified U-NII Detection Bandwidth criterion.

2. Starting at the center frequency of the UUT operating Channel, increase the radar frequency in 1 MHz steps, repeating the above test sequence, until the detection rate falls below the U-NII Detection Bandwidth criterion. Record the highest frequency (denote as FH) at which detection is greater than or equal to the U-NII Detection Bandwidth criterion. Recording the detection rate at frequencies above FH is not required to demonstrate compliance.

3. Starting at the center frequency of the UUT operating Channel, decrease the radar frequency in 1 MHz steps, repeating the above test sequence, until the detection rate falls below the U-NII Detection Bandwidth criterion. Record the lowest frequency (denote as FL) at which detection is greater than or equal to the U-NII Detection Bandwidth criterion. Recording the detection rate at frequencies below FL is not required to demonstrate compliance.

As described above, the test should be repeated for a lot of times in order to evaluate and gather statistics of the radar signal detection rate.

In addition, the requirements of KDB 905462 7.8.4—Statistical Performance Check announced by Federal Communications Commission (FCC) are as follows: Repeatedly perform the test for many times so as to evaluate and gather statistics of the radar signal detection rate.

However, most currently available radar signal generators for simulating radar waveform use common chassis-type VSG and PXI chassis-type VSG for test, so these radar signal generators cannot be easy to carry around because their size is too large. Besides, the currently available radar signal generators cannot automatically determine whether the wireless network devices detect the radar signals in the test mode, but should manually determine the test results. Further, the currently available radar signal generators have no the function of automatically switching FH-FL of different radar signal frequencies, so fail to conform to the requirements of Federal Communications Commission (FCC).

Thus, it has become an important issue to solve the problems that the currently available radar signal generators are too large in size and cannot automatically determine whether the wireless network devices detect the radar signals.

### SUMMARY OF THE INVENTION

To achieve the foregoing objective, the present invention provides a portable radar detection dynamic frequency selection automatic test device in order to solve the problem that the size of the currently available radar signal generators is too large. In addition, the test device can further automatically determine the test result and simultaneously integrate the software and hardware into a computer host platform to effectively realize the troubleshooting to find out the types of the radars which wireless network devices cannot detect in order to facilitate the development of wireless network devices and achieve the real-time monitoring effect.

To achieve the foregoing objective, the portable radar detection dynamic frequency selection automatic test device in accordance with the present invention mainly includes a radar signal generator and a processing unit. The radar signal generates includes at least one USB connection interface and at least one radar signal transmission interface. The processing unit is installed inside a computer host. According to the present invention, the radar signal generator is plugged into the USB connection interface to connect to the computer host connected to a wireless network device, and obtains a radar signal waveform file transmitted from the computer host via the USB connection interface. Then, the radar signal generator generates a radar signal and transmits the radar signal to the wireless network device via a radar signal transmission interface. Meanwhile, the built-in processing unit of the computer host performs a radar detection rate test in order to determine whether the wireless network device detects the radar signal.

More specifically, the portable radar detection dynamic frequency selection automatic test device in accordance with the present invention includes only the radar signal generator, the USB connection interface and the radar signal transmission interface for data transmission. Other hardware devices, such as hard disk drive, random access memory, heat dissipation device, screen panel, etc., are provided by the computer host. Therefore, the radar signal generator can be developed by Field Programmable Gate Array (FPGA), so the size of the radar signal generator can be reduced to 12.5 cm×9.4 cm×3.8 cm and the weight thereof can be decreased to 0.6 kg, which can significantly decrease the size and the cost of the hardware of the portable radar detection dynamic frequency selection automatic test device.

Besides, the processing unit can automatically determine whether the wireless network device detects the radar signal in the radar detection rate test no matter the wireless network device is operated in the normal mode or the test mode.

Moreover, the processing unit determines whether the wireless network device detects the radar signal according to the IP connection and/or log file.

Regarding using the IP connection, as different wireless network devices have different IPs and each can have its own program, so the processing unit can keep checking the connection status with each of the wireless network devices. Regarding using the log file, in the test mode some wireless network devices can still use the log files generated by these wireless network devices even if being disconnected from computers and the log files can keep record the implementation conditions. Therefore, the keyword search can be performed via a program in order to confirm whether there is a record showing that the wireless network device detects the radar signal. However, the length of the content of the log file varies with the test time. So as to reduce the time of searching the keywords, the processing unit estimates the column block range where the keywords appear according to the dynamic correction time, which can significantly decrease the searching time and increase the test speed.

### BRIEF DESCRIPTION OF THE DRAWINGS

For a better understanding of the aforementioned embodiments of the invention as well as additional embodiments thereof, reference should be made to the Description of Embodiments below, in conjunction with the following drawings in which like reference numerals refer to corresponding parts throughout the figures.

FIG. 1 is schematic view of a portable radar detection dynamic frequency selection automatic test device in accordance with a preferred embodiment of the present invention.

FIG. 2 is flow chart of the portable radar detection dynamic frequency selection automatic test device determining whether the radar signal is detected.

### DETAILED DESCRIPTION OF THE PREFERRED EMBODIMENT

The following description is about embodiments of the present invention; however it is not intended to limit the scope of the present invention.

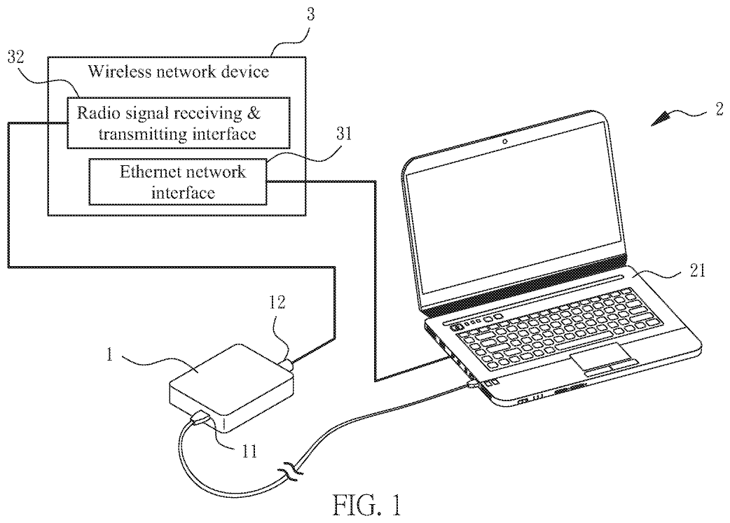

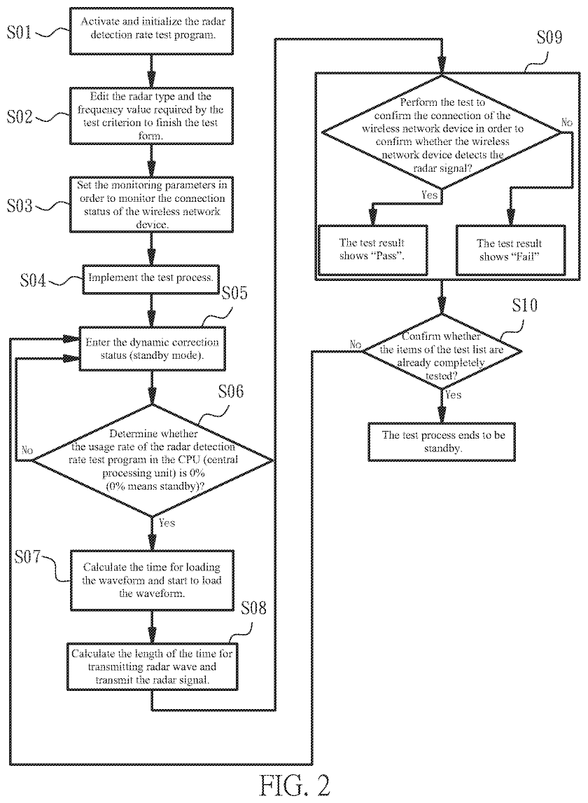

Please refer to FIG. 1 and FIG. 2. The portable radar detection dynamic frequency selection automatic test device in accordance with the present invention mainly includes a radar signal generator 1, a computer host 2 and a wireless network device 3. The radar signal generator 1 includes at least one USB connection interface 11 and at least one radar signal transmission interface 12.

The computer host 2 includes a built-in processing unit 21 and the wireless network device 3 includes at least one Ethernet network interface 31 and at least one radio signal receiving & transmitting interface 32.

More specifically, the wireless network device 3 is connected to the computer host 3 and the radio signal receiving & transmitting interface 32 of the wireless network device 3 is connected to the radar signal transmission interface 12 of the radar signal generator 1.

When the portable radar detection dynamic frequency selection automatic test device of the present invention is in operation, the radar signal generator 1 is plugged into the USB connection interface 11 to connect to the computer host 2. Then, the computer host 2 transmits a radar signal file to the radar signal generator 1 via the USB connection interface 11. After the above transmission is completed, the radar signal generator 1 generates a radar signal and transmits the radar signal to the radio signal receiving & transmitting interface 32 of the wireless network device 3 via the radar signal transmission interface 12. At the moment, the processing unit 21 of the computer host 2 performs the radar detection rate test in order to determine whether the wireless network device 3 detects the radar signal. The radar detection rate test includes the following steps:

S01: activate and initialize the radar detection rate test program.

S02: edit the radar type and the frequency value required by the test criterion to finish the test form.

S03: set the monitoring parameters in order to monitor the connection status of the wireless network device.

S04: implement the test process.

S05: enter the dynamic correction status (standby mode).

S06: determine whether the usage rate of the radar detection rate test program in the CPU is 0% (0% means standby); if it is, the process proceeds to the step S07; if it is not, the process returns to the step S05.

S07: calculate the time for loading the waveform and start loading the waveform.

S08: calculate the length of the time for transmitting radar wave and transmit the radar signal.

S09: perform the test to confirm the connection of the wireless network device in order to confirm whether the wireless network device detects the radar signal; if the wireless network device detects the radar signal, the test result shows “Pass”; if the wireless network device fails to detect the radar signal, the rest result shows “Fail”.

S10: confirm whether the items of the test list are already completely tested; if they are, the test process ends to be standby; if they are not, the test process returns to the step S05.

More specifically, in the step S02, editing the radar type and the frequency value means: the user should use the various built-in radar types in the radar detection rate test program to mark the frequency point which each of the radar types should transmit the radar signal at because different wireless network devices have different operating frequencies so as to satisfy the test requirements of the criterion.

TABLE 1

| A | B |
|---|---|
| FCC-Reference#-3M | 5.28 G |
| FCC-Type1A-1_1#-3M | 5.50 G |
| FCC-Type1A-1_2#-3M | 5.28 G |
| FCC-Type1A-1_3#-3M | 5.28 G |
| FCC-Type1A-1_4#-3M | 5.28 G |

As shown in Table 1, Zone A shows the built-in radar types. The test form can be finished just by filling in the frequency points corresponding to Zone B. when the test starts, the radar detection rate test program transmits the necessary files and information to the radar signal generator so as to generate the corresponding radar signal.

Regarding the step S03, setting the monitoring parameters means determining whether the wireless network device detects the radar signal according to the IP connection status or the content inside the log file. Moreover, the details of the determination method should be further set. If the IP connection status is used, the IP address of the wireless network device should be set. If the log file is used, the path of the log file and the keywords in the content thereof should be set.

Further, the dynamic correction status means: the size of the waveform may be different in response to the requirements of different radar signals. Thus, the time of loading the waveform is not constant. It is necessary to dynamically check the time point of the connection status in order to avoid that the time point of the connection status of the wireless network device is incorrect because the loading time is not constant. The connection time point of the wireless network device 3=the time of loading the waveform+the transmitting time of the radar signal+the releasing time of the memory; the above time is the one-time test cycle.

As described above, the portable radar detection dynamic frequency selection automatic test device according to the present invention includes only the radar signal generator 1, the USB connection interface 11 and the radar signal transmission interface 12 for data transmission. Other hardware devices, such as hard disk drive, random access memory, heat dissipation device, screen panel, etc., are provided by the computer host 2. Therefore, the radar signal generator 1 can be developed by Field Programmable Gate Array (FPGA), so the size of the radar signal generator 1 can be reduced to 12.5 cm×9.4 cm×3.8 cm and the weight thereof can be decreased to 0.6 kg, which can significantly decrease the size and the cost of the hardware of the portable radar detection dynamic frequency selection automatic test device. Accordingly, the portable radar detection dynamic frequency selection automatic test device according to the present invention can perform the test only by connecting the USB connection interface 11 to the computer host 2 with the built-in processing unit 21. Thus, the user can swiftly establish the test environment even if in the small table of an office. On the contrary, it is necessary to move heavy test instruments to a large space to establish the test environment for the currently available test devices. Moreover, compared with the currently available test devices, the portable radar detection dynamic frequency selection automatic test device of the present invention can automatically determine whether the wireless network device 3 detects the radar signal. Furthermore, the portable radar detection dynamic frequency selection automatic test device of the present invention can always automatically determine whether the wireless network device 3 detects the radar signal no matter the wireless network device 3 is operated in the normal mode or the test mode.

The above disclosure is related to the detailed technical contents and inventive features thereof. Those skilled in the art may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. A portable radar detection dynamic frequency selection automatic test device, comprising:
a computer host, comprising a processing unit built therein and connected to a wireless network device;
a radar signal generator, comprising at least one USB connection interface connected to the computer host and at least one radar signal transmission interface connected to the wireless network device, wherein the radar signal generator obtains a radar signal from the computer host via the USB connection interface to generate a radar signal, and transmits the radar signal to the wireless network device via the radar signal transmission interface, whereby the processing unit of the computer host implements a radar detection rate test to determines the wireless network device detects the radar signal.

2. The portable radar detection dynamic frequency selection automatic test device of claim 1, wherein the wireless network device comprises at least one ethernet network interface and at least one radio signal receiving & transmitting interface; the wireless network device is connected to the computer host via the ethernet network interface and the radio signal receiving & transmitting interface is connected to the radar signal transmission interface of the radar signal generator.

3. The portable radar detection dynamic frequency selection automatic test device of claim 1, wherein when the processing unit implements the radar detection rate test, the processing unit automatically determines whether the wireless network device detects the radar signal according to an IP connection status of the wireless network device when the wireless network device in in a normal mode or a test mode, or by searching a keyword in a log file.

4. The portable radar detection dynamic frequency selection automatic test device of claim 3, wherein when the computer host is disconnected, the computer host is still able to use the log file generated by the wireless network device; the log file keeps recording implementation conditions and the processing unit determines whether the wireless network device detects the radar signal by searching the keyword to confirm whether there is a record showing that the wireless network device detects the radar signal.
